(19) United States
(12) Patent Application Publication
(10) Pub. No.: US 2019/0178751 A1
(43) Pub. Date: Jun. 13, 2019

(54) TESTING APPARATUS FOR GEARS

(71) Applicant: GE AVIO S.R.L., Rivalta di Torino (IT)

(72) Inventors: Michele Gravina, Minervino Murge (IT); Elio Perona, Cafasse (IT); Guido Rocca, Livorno (IT)

(21) Appl. No.: 16/308,100

(22) PCT Filed: Jun. 2, 2017
(86) PCT No.: PCT/EP2017/063561

§ 371 Date: Dec. 7, 2018

(30) Foreign Application Priority Data
Jun. 9, 2016 (IT) 102016000059279

(51) Int. Cl. G01M 13/021; G01N 3/04; G01N 3/34

(52) U.S. Cl. CPC G01M 13/021; G01N 3/34; G01N 3/04

(57) ABSTRACT

A test apparatus for testing a gear having a central axis has a force application column moveable along a force application axis (F) so as to apply a force onto the flank of a tooth of the gear, and a clamping device having a clamping axis (A) orthogonal to and spaced apart from the force application axis. The clamping device secures the gear in such a manner that the central axis of the gear coincides with the clamping axis (A). The column has a first and a second end and one intermediate portion, which is elastically deformable so as to allow for a displacement of the second end in relation to the first end along a displacement direction (D1) orthogonal to the clamping axis (A) and to the force application axis (F).

### TECHNICAL FIELD

The present invention relates to a test apparatus for testing gears, in particular a test apparatus for fatigue testing of gears.

### BACKGROUND OF THE DISCLOSURE

Gears have applications within transmission systems in different fields, as the automotive, the naval or the aeronautic fields.

The gears applied in aeronautical transmission systems have to satisfy extremely demanding reliability and durability requirements.

A common parameter for evaluating the reliability and durability of gears is the fatigue strength, which is estimated by means of fatigue tests performed on specific test rigs.

In the commonly known test rigs, the tested gear is clamped in a fixed position on a test apparatus and a force is applied onto the flank of one or more teeth of the gear by means of an actuator and a force application column which transfers the force from the actuator onto the above mentioned flank along a force application direction.

In some of the test rigs, the force application column typically is provided in the form of a rigid anvil and acts by means of an interaction element simultaneously on the flanks of two adjacent teeth.

In other test rigs the interaction element of the force application column applies the force on the flank of a single tooth. However, during the application of the force such tooth is deformed, so that the interaction element can slide over the flank. In these cases, the interaction element contacts the flank at a position that can slightly vary during the test.

This limits the possibility to obtain precise results from the test measurements because of the uncertainty associated to the friction at the tooth flank surface.

A test rig applying the force onto the flank of a single tooth along a force application direction is disclosed in CN-U-202083601. The test rig comprises a clamping device for clamping the gear in such a manner that the central axis of the gear is coaxial with a clamping axis, the clamping axis being orthogonal to the force application direction. The test rig also has a force application column provided with two elastically deformable plate portions, which are aligned with each other and are arranged between respective rigid portions of the force application column. Each of the plate portions is deformable and give a certain freedom of movement to the end of the column along a deformation direction parallel to the clamping axis.

However, this freedom of movement cannot compensate for the deformation of the tooth and obtain a stable contact point between the column and the flank of such tooth.

Overall, a drawback of the known test rigs is that they permit comparative tests between different gears, but they are limited in their possibility and reliability of obtaining absolute results in terms of gears fatigue strength data.

### BRIEF DESCRIPTION

It is therefore an object of the present invention to provide a test apparatus to overcome, in a straightforward and low-cost manner, the aforementioned drawbacks.

According to the present invention, there is provided a test apparatus as claimed in claim 1.

There is furthermore provided a test rig as claimed in claim 13.

### BRIEF DESCRIPTION OF THE DRAWINGS

One non-limiting embodiment of the present invention will be described by way of example with reference to the accompanying drawings, in which:

FIG. 1 shows a perspective view of a test rig having an embodiment of the test apparatus according to the present invention, with parts removed for clarity;

FIG. 2 shows a perspective view of another side of the test apparatus of FIG. 1, with parts removed for clarity;

FIGS. 3A and 3B shows a detail of the test apparatus of FIGS. 1 and 2, being in two different configurations; and

FIG. 4 is a sectioned view along plane IV of FIG. 2 and shows another detail of the test apparatus of FIGS. 1 and 2.

### DETAILED DESCRIPTION

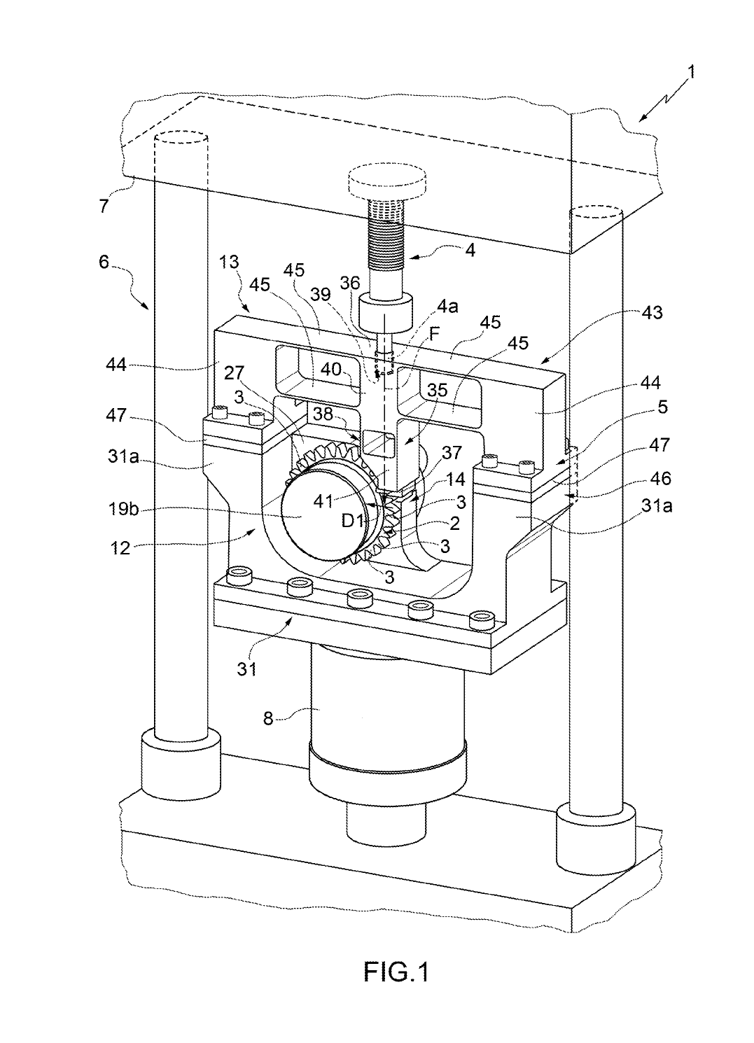

Number 1 in FIG. 1 indicates, as a whole, a test rig for testing a gear 2 having a plurality of teeth 3, in particular for fatigue testing of gear 2.

Rig 1 comprises:

an actuator 4 for generating a force along a force application axis F, in particular force application axis F having a vertical orientation; and a test apparatus 5 securing and clamping gear 2, coupled to actuator 4 and configured to transfer the force generated by actuator 4 onto the flank of a single tooth 3 of gear 2.

Rig 1 furthermore has a support structure 6 for carrying actuator 4 and test apparatus 5.

In particular, support structure 6 comprises an upper transversal bar 7 carrying actuator 4 and a base 8 supporting test apparatus 5.

With reference to FIGS. 1 to 4, apparatus 5 comprises:

a clamping device 12 clamping and securing gear 2 in a fixed position within apparatus 5; and

a force application frame 13 configured to transfer the force generated by actuator 4 towards the flank of the tooth 3 of gear 2.

In more detail, clamping device 12 comprises:

a single support block 14 having one through passage 15 extending along a central axis A, with an orientation that is transversal, in particular orthogonal, to axis F; and a shoulder 16 transversal to axis A and, in particular orthogonal to axis A and parallel to axis F; and a securing bolt 17 axially extending through passage 15, having a shoulder 18 and comprising a pin 19 and a tightening member 20 screwed on pin 19 so as to axially clamp gear 2 in fixed position between shoulders 16 and 18.

More specifically, pin 19 has a threaded portion 19a axially protruding from passage 15, and tightening member 20 is defined by a nut element secured on threaded portion 19a.

Furthermore, support block 14 comprises a fixed protrusion 24, in particular having a cylindrical outer surface 24a, axially projecting with respect to shoulder 16 and defining an axial end portion 15a of passage 15. Gear 2 is directly fitted onto outer surface 24a. Additionally, shoulder 18 is axially spaced apart from protrusion 24 so as to leave a gap allowing for transferring the axial clamping force only onto gear 2, and not onto protrusion 24.

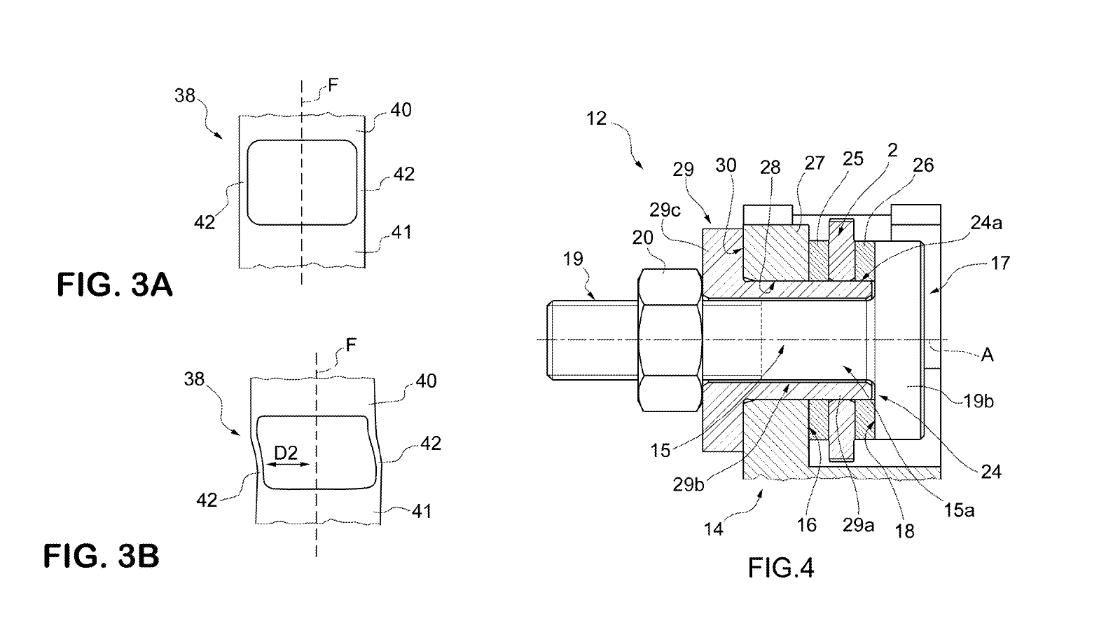

With particular reference to FIGS. 3 and 4, clamping device 12 further comprises a first and a second spacer element 25, 26, directly fitted onto outer surface 24a of protrusion 24 and arranged between shoulders 16 and 18. Spacer elements 25, 26 are arranged on the opposite sides of gear 2, so as to sandwich in between gear 2.

Furthermore, the axial thickness of spacer element 25 is identical to the axial thickness of spacer element 26, so as to avoid errors in positioning the spacer elements 25,26 during the operations carried out to mount gear 2 in clamping device 12. The axial thickness of spacer elements 25 and 26 depend on the axial thickness of gear 2 to be tested and is chosen during the mounting stage so as to align the tooth to be tested and center the axial position of such tooth with force application axis F.

In more detail, support block 14 comprises:

a single support plate 27, which projects in a fixed position transversally to axis A and substantially parallel to force application axis F, defines shoulder 16 and has a cylindrical seat 28, coaxial with passage 15 along axis A; and a positioning pin 29 defining the whole passage 15 and comprising a hollow cylindrical portion 29b that engages seat 28 with an interference fit, so as to be fixed with respect to support plate 27.

In other words, the outer diameter of the portion 29b is equal to the diameter of seat 28, apart from the manufacturing tolerances that have to ensure the interference coupling.

Additionally, an end portion 29a of positioning pin 29 defines protrusion 24.

Positioning pin 29 further comprises a flange 29c. Flange 29c axially rests onto a contact surface 30 of support block 14 axially opposite of shoulder 16 and provided on support plate 27.

In particular, positioning pin 29 is mounted into seat 28 by means of a press fit, so as to axially insert cylindrical portion 29b into seat 28 until flange 29c comes into axial contact with surface 30.

In particular, tightening member 20 axially and directly rests onto flange 29c. In the meantime, pin 19 comprises a head 19b axially and directly resting onto spacer element 26 and defining shoulder 18.

According to a variant (not shown), the positions of head 19b and tightening member 20 is inverted, so that shoulder 18 is defined by tightening member 20. According to another variant, shoulder 18 is defined by a further tightening member, in particular a further nut element which is tightened on a threaded portion of pin 19, at the axial end opposite to tightening member 20.

In the an embodiment that is shown in the attached drawings, it is clear that protrusion 24 and shoulder 16 are defined by two distinct work pieces, i.e. pin 29 and support plate 27, so as to simplify the manufacturing operations for obtaining support block 14.

As an alternative (not shown), support plate 27 and protrusion 24 are provided as a single work piece, without the need of press coupling operations.

Overall, shoulder 18 is in contact with spacer element 26, spacer element 26 is in contact with gear 2 from a first side of gear 2, spacer element 25 is in contact from a second side of gear 2 opposite of the first side, spacer element 25 is also in contact with shoulder 16: friction between these contact areas defines the transversal and angular retention of the gear 2. Such friction is a function of the axial load exerted by tightening member 20, which in turn is a function of the driving torque of tightening member 20.

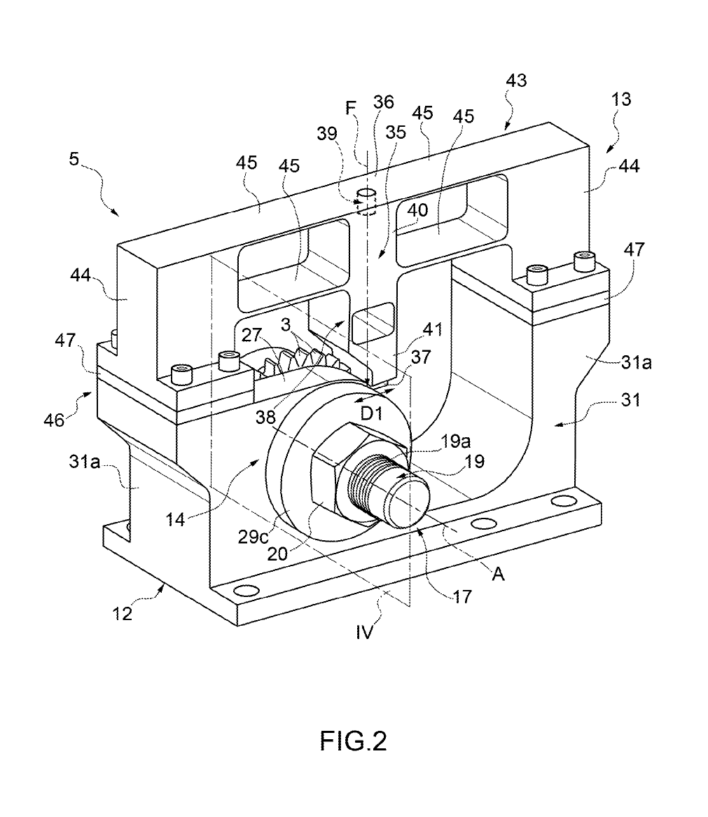

Further on, with particular reference to FIGS. 1 and 2, support block 14 defines part of a support frame 31, which, in more detail, is fixed on base 8.

Furthermore, force application frame 13 comprises a single force application column 35, which is aligned with actuator 4 and is elongated along force application axis F. Column 35 is adapted to interact with the flank of the tooth 3 of gear 2 for applying the force exerted by actuator 4 on the flank of the tooth 3.

More specifically, column 35 is moveable along force application axis F with respect to clamping device 12 under the action of actuator 4 and exerts the force onto the flank of tooth 3. Furthermore, column 35 is orthogonal and radially spaced apart with respect to axis A.

With particular reference to FIGS. 1, 2, 3A and 3B, column 35 comprises:

a first end 36 coupled to a moveable section 4a of actuator 4; a second end 37, axially opposite to end 36 and configured to contact the flank of the tooth 3 at a contact area; and at least one intermediate portion 38, which is axially arranged between ends 36 and 37 and which is elastically deformable so as to allow for a displacement of end 37 in relation to end 36 along a displacement direction D1 orthogonal to force application axis F and to axis A.

In particular, end 36 has a recess 39 receiving the axially moveable section 4a. In further detail, column 35 comprises a first and a second rigid portion 40, 41 and the intermediate portion 38 being arranged between portions 40 and 41. In particular, end 36 defines a part of portion 40, while portion 41 carries end 37. In the shown embodiment, end 37 is defined by a separate piece mounted to portion 41 in a fixed position. However, it must be understood that end 37 and portion 41 could be defined by one single work piece.

According to an aspect of the present invention, intermediate portion 38 comprises at least one deflectable member, in particular two bendable plate elements 42, connecting portions 40 and 41 with each other. In an un-deformed condition, the plate elements 42 are substantially parallel to force application axis F and are elastically bendable about rotation axes that are parallel to axis A, so as to allow a movement of portion 41 along a direction D2, parallel to the above identified direction D1, with respect to portion 40.

In more detail, bendable plate elements 42 are spaced apart from each other along direction D2 and are arranged parallel to each other. FIG. 3A shows intermediate portion 38, and in particular plate elements 42, prior to the application of a force on the flank of the tooth 3. FIG. 3B shows intermediate portion 38, and in particular plate elements 42, during the application of a force on the flank of the tooth 3, when such tooth 3 deforms and this deformation causes a displacement of the contact area with the end 37. Please note that FIG. 3B shows a deformation that is enlarged and does not represent the real condition, so as to highlight the displacement along direction D2 for sake of clarity.

It should be noted that intermediate portion 38 behaves just like a four-bar linkage (see FIG. 3B). Therefore, portion 41 and end 37 translate along direction D2, D1 without rotations.

Additionally, with reference to FIG. 2, force application frame 13 comprises a carrier structure 43 moveably carrying column 35.

Carrier structure 43 comprises:

two lateral rigid support pillars 44; and four flexible connecting members, in particular connecting plate arms 45, which are fixed to portion 40 at two opposite sides of column 35 and each one being fixed to a respective rigid support pillar 44.

Each one of connecting plate arms 45 is bendable about rotation axes that are parallel to axis A, so as to allow for the displacement of portion 40 and, therefore, for guiding the movement of column 35 along force application axis F.

In even more detail, in an un-deformed condition, connecting plate arms 45 are parallel to each other and orthogonal to force application axis F. Furthermore, connecting plate arms 45 are symmetric with respect to a symmetry plane in which force application axis F lies.

In the specific embodiment, the pillars 44, the connecting plate arms 45, the intermediate portion 38 and portions 40 and 41 of column 35 are formed as one single work piece. As mentioned above, end 37 is provided as a separate piece mounted to portion 41.

With particular reference to FIGS. 1 and 2, apparatus 5 further comprises height adjusting means 46 configured to adjust the height of pillars 44, in particular to define the distance of end 37 from the flank of tooth 3, prior to the exertion of the force. In this way, apparatus 5 can be setup to test gears 2 having the same base diameter, but different numbers of teeth and/or to load the same tooth at different radii of the involute profile.

In more detail, height adjusting means 46 comprise at least two distancing elements 47, each one interposed between one respective rigid support pillar 44 and one respective support beam 31a of clamping device 12. In particular, by replacing distancing elements 47 of one thickness with distancing elements 47 of another thickness it is possible to define the distance of end 37 from the flank of tooth 3.

Apparatus 5 also comprises a sensor device (not shown) configured to determine the stress applied by column 35 on the flank of tooth 3. In particular, the sensor device comprises a plurality of strain gauges positioned onto plate arms 45 and onto plate elements 42, so as to detect the deformation of such parts and therefore to determine the above mentioned stress on the basis of such deformation. Additionally, actuator 4 is configured to provide for displaying the force generated by actuator 4 itself.

In use, prior to the testing, gear 2 is clamped and secured by clamping device 12.

More specifically, gear 2 is fitted onto outer surface 24a of protrusion 24. Radial clearance between protrusion 24 and gear 2 is avoided because the diameter of surface 24a is set during the design stage so as to be substantially equal to the inner diameter of the gear 2, in particular with a very tight clearance to enable manual assembly and disassembly without introducing significant uncertainties in the location of the loaded point on the tooth flank.

Gear 2 is angularly and axially secured by tightening member 20 onto the pin 19, so as to sandwich and clamp gear 2 between shoulders 16 and 18.

Prior, but possibly also after, the clamping of gear 2, height adjusting means 46 are, in case of need, selected to set the height of pillars 44 in order to prepare apparatus 4 to the specific gear 2 to be tested. Therefore, the distance of end 37 to the flank of tooth 3 is set by height adjusting means 46. More specifically, pillars 44 are moved away from support beams 31a and the distancing elements 47 present are removed and are replaced with distancing elements 47 having the desired thickness. Then the pillars 44 are placed again on distancing elements 47 and pillars 44 and support beams 31a are fixed to each other.

Once the gear 2 is secured within clamping device 12 and the desired distance between end 37 and the flank of the tooth 3 is set, the actual test of gear 2 is initiated.

Actuator 4 is activated to drive column 35 along force application axis F and column 35 transfers the force on the flank of the tooth 3. Therefore, activation of actuator 4 leads to movement of column 35 along force application axis F.

During the application of the force by actuator 4 movement of column 35 along force application axis F is guided by deflection of connecting plate arms 45.

During movement of column 35, end 37 permanently contacts the flank of tooth 3. During force application, the tooth 3 elastically deforms, so that the position of the contact area can slightly change under load.

Thanks to the flexibility of intermediate portion 38, end 37 can move along direction D1, together with the deformation of the tooth 3, so as to adapt its position as a function of the deformation and to avoid a sliding along the flank of the tooth 3. In other words, end 37 automatically follows the deformation of the tooth 3 by displacing with respect to end 36. As a final consequence, end 37 continues to contact the flank of tooth 3 at the same and only contact area, notwithstanding the possible movement of such contact area.

More specifically, the relative movement of end 37 with respect to end 36 is provided for by the bending of plate elements 42 along the deformation direction D2 (see FIG. 3B) upon the application of the force on the flank of tooth 3.

This compensation or adaptation carried out by the intermediate portion 38 is reached by a single piece, i.e. the ensemble of portions 40, 41 and 38, so that no clearance is provided between portions 40 and 38 and between portions 38 and 41.

In particular, the opposite roots of the plate elements 42 define respective virtual hinges that allow for deflection of portion 38 as a four-bar linkage and, therefore, for a pure translation of portion 41.

The advantages of test apparatus 5 according to the present invention are clear from the foregoing description.

Overall, test apparatus 5 allows to exert the force onto an unchangeable contact area of the flank of tooth 3 upon the test. In other words, the elasticity of the intermediate portion 38 provides for the contact area staying the same throughout the complete test. This result contributes to a more accurate evaluation of the gear fatigue properties because it prevents the detrimental effects of micro-sliding on the contacting surfaces.

Furthermore, connecting plate arms 45 allow to precisely define and guide movement of force application column 35 along force application axis F. Just as for the plate elements 42, plate arms 45 are not pieces separate from pillars 44 and portion 40, so that clearance is completely avoided.

In particular, the opposite roots of plate arms 45 define respective virtual hinges that allow for deflection of the plate arms 45, as a four-bar linkage at each side of the column 35, and allow, therefore, for a pure translation of the column 35 along direction D1. In the meantime, the symmetry of the plate arms 45 allows for maintaining axis F always in the same position.

In particular, the pillars 44, the connecting plate arms 45, the intermediate portion 38 and portions 40 and 41 of column 35 are formed as one single work piece. The complexity of test apparatus 5 is reduced with respect to the known test apparatuses, and clearances are completely avoided, as mentioned above, while movements of the end 37 along axis F and along direction D1 are allowed.

Overall, test apparatus 5 allows for obtaining absolute fatigue strength data, thanks to the very accurate loading system and the absence of friction at the loaded tooth contact point.

A further advantage is seen in height adjusting means 46 of test apparatus 5 providing for a simple setup of the test apparatus 5, in particular by choosing the correct thickness of distancing elements 47.

Clearly, changes may be made to test apparatus 5 as described herein without, however, departing from the scope of protection as defined in the accompanying claims.

What we claim is:

1. A test apparatus for testing a gear having a central axis, the test apparatus comprising:
a force application column elongated along a force application axis (F) and moveable along said force application axis (F) so as to apply an axial force onto the flank of a tooth of the gear; and
a clamping device having a clamping axis (A) orthogonal to and spaced apart from the force application axis (F) and being configured to clamp and secure the gear in a fixed position in such a manner that the central axis of the gear coincides with the clamping axis (A) in the test apparatus;
the force application column comprising:
a first end;
a second end, axially opposite to said first end and configured to contact the flank of the tooth at a contact area; and
at least one intermediate portion, which is axially arranged between said first and second ends and is elastically deformable so as to allow for a displacement of the second end in relation to the first end along a displacement direction (D1) transversal to the force application axis (F);
wherein said displacement direction (D1) is orthogonal to the clamping axis (A) and to the force application axis (F).

2. The test apparatus according to claim 1, wherein the intermediate portion comprises at least one deflectable member, which connects a first and a second rigid portion of the force application column, substantially extends parallel to the force application axis (F), in an un-deformed condition, and is bendable about rotation axes parallel to said clamping axis (A).

3. The test apparatus according to claim 2, wherein at least one deflectable member and the first and second rigid portion define parts of a single piece.

4. The test apparatus according to claim 2, wherein the intermediate portion comprises two bendable plate elements spaced apart from each other along a direction (D2) parallel to said displacement direction (D1).

5. The test apparatus according to claim 4, wherein the bendable plate elements are arranged parallel to each other, in an un-deformed condition.

6. The test apparatus according to claim 1, wherein further comprising:
at least two lateral rigid support pillars; and
at least two flexible connecting arms fixed to the first end of the force application column at two opposite sides of the force application column and each one being fixed to one respective rigid support pillar;
each of the flexible connecting arms being bendable about a further rotation axes that are parallel to the clamping axis (A) for guiding the movement of the force application column along said force application axis (F).

7. The test apparatus according to claim 6, wherein at least two flexible connecting arms are symmetric with respect to a symmetry plane in which said force application axis (F) lies.

8. The test apparatus according to claim 6, wherein comprising four flexible connecting arms.

9. The test apparatus according to claim 6, wherein the flexible connecting arms are defined by connecting plate arms, that extend orthogonally to the force application axis (F) in an un-deformed condition.

10. The test apparatus according to claim 6, wherein further comprising height adjusting means configured to adjust the height of the pillars.

11. The test apparatus according to claim 10, wherein the height adjusting means comprise at least two distancing elements, each one interposed between one respective rigid support pillar and one respective support beam of the clamping device.

12. The test apparatus according to claim 6, wherein the first end of the force application column, the at least two lateral rigid support pillars and the at least two flexible connecting arms are defined by a single piece.

13. A test rig for testing a gear, the test rig comprising:
a fixed support structure;
an actuator carried by said support structure and controlled for generating a force to be applied onto the flank of a tooth of the gear; and
a test apparatus according to claim 1, carried by said support structure; and the force application column being coupled to said actuator.
